(19) United States
(12) Patent Application Publication
(10) Pub. No.: US 2007/0214436 A1
(43) Pub. Date: Sep. 13, 2007

(54) POSITIONAL NAVIGATION GRAPHIC LINK SYSTEM

(76) Inventor: Raymond LeRoi Myers JR., Vestal, NY (US)

Correspondence Address: Raymond Myers, 2957 State Route 26, Vestal, NY, 13850, US

(21) Appl. No.: 11/684,626

(22) Filed: Mar. 11, 2007

Related U.S. Application Data
(60) Provisional application No. 60/781,808, filed on Mar. 13, 2006.

(51) Int. Cl. G06F 3/048

(52) U.S. Cl. 715/856

(57) ABSTRACT

The present invention is a positional navigation link system for displaying an active graphic symbol or cluster of symbols at a user-selected location on a display screen. At least one active graphic symbol is stored on the system. The active graphic symbol(s) can represent, for example, close, minimize, go to previous page, go to next page, go to top of window, go to bottom of window, refresh, save and print. The active graphic symbol(s) are displayed at a location on the display screen selected by a user. Each function represented by each active graphic symbol is executable by the user, so that both the active graphic symbol(s) and the function(s) represented thereby are conveniently accessible. The location on the display screen at which the active graphic symbol(s) appear is at the tip of the mouse pointer or, in the case of laptop or notebook computers used without benefit of a mouse, at the tip of the display pointer.

### CROSS-REFERENCE TO RELATED APPLICATIONS

What is desired to be protected by Letters Patent is referred to and priority is claimed in provisional patent application 60/781,808 with a filing date of Mar. 13, 2006.

### FIELD OF THE INVENTION

The present invention pertains to graphical user interfaces (GUIs) and, more particularly, to a pointer-centric, positional navigation graphic link system.

### BACKGROUND OF THE INVENTION

Graphical user interfaces (GUIs) have evolved over the years to be more understandable and usable by users. Current GUIs use menu names, graphic symbols, URL links and a point and click device (e.g., a mouse) to accomplish desired user tasks such as change fonts, go to a web site, and close the current window. A greater reliance on graphical symbols and icons has helped improve users' comfort and efficiency when using computers.

Nevertheless, the use of graphics, in some cases, has resulted in a user requiring more time, effort and accuracy to accomplish a specific function. For example, the Windows®, Macintosh and Linux operating systems navigation symbols as well as all current web browsers, such as Internet Explorer 7.0, are located far at the top of the display screen in predetermined locations. This symbol placement continually requires increased time, effort and accuracy in navigating documents, particularly web pages, and particularly with users of laptops and notebook computers where there is no mouse pointing device available at the time.

The symbol for “close the window” is located at the upper right-hand corner of the current window and requires time-consuming, sweeping, accurate mouse movements. Likewise, the symbol for “minimize the window” is located just next to the close window symbol. Symbols for “go to previous window,” “go to next window,” and “refresh current window” are usually located at the upper-left-hand corner of the current window.

It would be advantageous to provide a mechanism by which a computer user could initiate one of the aforementioned functions without having to move his or her mouse pointer to the far reaches of the computer screen. This would be particularly advantageous to, but not limited to, users of portable computing devices where there is no convenient pointing device attached and users must make a series of finger movements in a rectangular navigation panel (touchpad) area of the portable computer to move the display pointer to the far corners of their screens in order to reach the appropriate navigation symbols.

It would also be advantageous to provide a mechanism to reduce time, effort and the need for accuracy in executing such functions, especially when significant navigation activity (i.e., Internet “surfing”) is involved.

It would also be advantageous to provide a mechanism by which a computer user could navigate among a plurality of documents without having to make sweeping and accurate mouse movements.

It would further be advantageous to provide a system by which a single click of a mouse button would be enough to summon an icon, a cluster of icons, or, in the case of the right-click, a cluster of icons proximate to a drop-down menu, without having to traverse a large portion of a display screen with a mouse.

It would also be advantageous to provide a system by which movements of the mouse or display pointer to a “white space” area (an area in which no executable actions appear) of the display screen summon an icon or a cluster of icons without having to traverse a large portion of a display screen with a mouse or finger movements in a navigation panel (touchpad) area of a portable computing device. This is particularly labor-saving for users of portable computing devices such as laptops and notebook computers where there is no mouse pointing device available.

Prior art in this field limit their solutions to mouse gestures which have to be learned or center-of-screen-only presentation of the clustered symbols. The invention eliminates these two hurdles making window navigation, particularly on the Internet and particularly on a “mouseless” portable computing device, timely, effortless and accurate.

There have been several attempts to make it easy for computer users to invoke computer operations while reducing the distance traveled by the display pointer to invoke those operations. One method is to move the display pointer in a certain predetermined configuration; e.g.—“up, then down”, “up-‘u’ shaped, then down”, etc. This method requires prior knowledge of display/mouse movements to invoke an operation and is not as efficient as the invention.

The patent that most closely resembles the invention is U.S. Pat. No. 6,883,143 to Driskell, Dec. 18, 2001. In it, he references U.S. Pat. No. 5,596,699, January, 1997 to Driskell; U.S. Pat. No. 5,880,723, March, 1999 to Driskell; U.S. Pat. No. 6,144,962, November, 2000 to Weinberg et al.; U.S. Pat. No. 6,239,803, May, 2001 to Driskell; U.S. Pat. No. 6,275,227, August, 2001 to DeStefano; and, U.S. Pat. No. 6,295,509, September, 2001 to Driskell.

The inventor, Driskell, titles his invention “Computer interface toolbar for acquiring most frequently accessed options using short cursor traverses”. Where our inventions differ is that he claims that “display of the plurality of user-selectable display areas associated with a plurality of computer operations” is a “central-area associated with said interactive display”. My invention places the display areas (cluster of symbols) central to the display pointer (“pointer-centric”), thus the short traverses or display pointer movements become shorter and thus timelier, effortless and with potentially greater accuracy.

Driskell continues on in all of his claims asserting the principle of “a central-area associated with said interactive display”. Thus, the uniqueness of my invention is the cluster's proximity to the display/mouse pointer as well as its ability to appear, next to the pointer, with just the simple movement of the display pointer/mouse pointer to a white space. This is particularly useful for laptop/notebook users without benefit of an attached mouse.

Objects and advantages of the invention include ease of launching the graphic with auto-launching after a movement of the display pointer to a “white space” area (an area in which no executable actions appear); display pointer centric location of the graphic for short pointer movement to the graphic-invoked function(s); and, appropriate grouping around the display pointer of only those most-often-used functions for navigation and saving and printing so that there is no learning curve, such as in the “mouse gestures” model for function launching efficiency.

### SUMMARY OF THE INVENTION

In accordance with the present invention, there is provided a positional navigation link system for displaying an active graphic symbol at a user-selected location, generally, the “tip” of the mouse or display pointer on a display screen. At least one active graphic symbol is stored on the system. The active graphic symbol can represent, for example, close the window, minimize the window, go to previous window, go to top of window, go to bottom of window, go to next window, and refresh the screen.

A mechanism is provided for displaying the active graphic symbol at the display or mouse pointer “tip” as viewed on the display screen. This method is selectable by the user. If more than one active graphic symbol is used, they can be displayed as a cluster. The symbol or cluster of symbols appears at the location on the display screen selected by a user when the user depresses a left mouse button, a right mouse button or moves the pointer to a blank, “white space”, (an area in which no executable actions appear) area.

For the left mouse button, the user presses and holds the left mouse button, an active graphic symbol or a cluster of symbols appears; the user then moves the mouse pointer to the desired action, represented by a particular symbol, and then releases the left mouse button and the action is undertaken.

For the right mouse button, the user clicks and releases the right mouse button; the standard drop-down menu appears along with an active graphic symbol or cluster of symbols displayed closely to the drop-down menu. The user moves the mouse pointer to the desired symbol and left clicks the desired symbol and the action is undertaken.

For portable computing device users where there is no mouse device currently available, users move the display pointer to a “white space” (an area in which no executable actions appear) area of the display screen. The symbol or cluster of symbols either appears automatically or the user “taps” the rectangular navigation panel (touchpad) area at which time the symbol(s) appear. The user moves the mouse pointer to the desired symbol and “taps” the desired symbol and the action is undertaken. In the case where there is no mouse button action or pointer movement, the symbol or cluster of symbols disappears after a short period of time.

In every case above, the actions taken by the user in conjunction with the various forms of the invention are intended to greatly reduce the time-consuming pointer movements necessary to invoke navigation and other actions represented by graphic symbols typically situated at the far reaches of the display screen.

The symbol or cluster of symbols is meant to be as small yet readable as possible and formed as close to the display pointer or mouse pointer as is possible. A minimum of actions is imagined as the primary function of the cluster is to facilitate window navigation and bring often used functions to the user rather than have the user go to the symbol and thus, the function.

### BRIEF DESCRIPTION OF THE DRAWINGS

A complete understanding of the present invention may be obtained by reference to the accompanying drawings, when considered in conjunction with the subsequent detailed description, in which:

FIG. 1 is a partial screen image depicting a cluster of symbols in accordance with the invention; and

FIG. 2 is an alternate embodiment of a cluster of symbols combined with a drop-down menu.

### DETAILED DESCRIPTION OF THE PREFERRED EMBODIMENT

In general, the invention is a positional navigation link system for displaying an active graphic symbol(s) at a user-selected location, generally, the “tip” of the mouse or display pointer, on a display screen. The function represented by the active graphic symbol(s) is executable by the user, so that both the active graphic symbol(s) and the function(s) represented thereby are conveniently accessible.

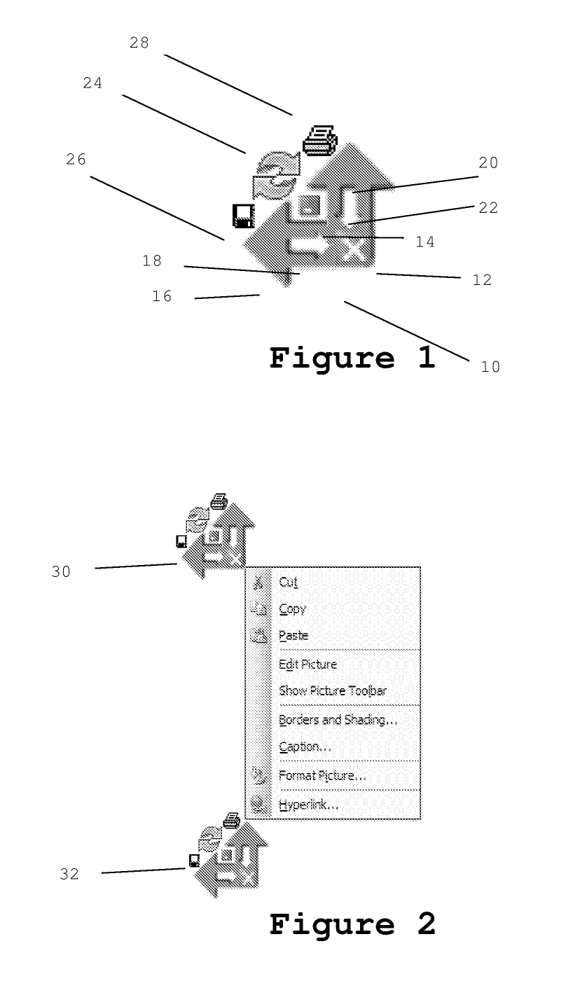

Referring now to FIG. 1, there is shown a partial screen image depicting a cluster of symbols 10 that represent the following functions: close the window 12, minimize the window 14, go to previous window 16, go to next window 18, go to top of window 20, got to bottom of window 22, refresh 24, save 26 and print 28. It should be understood that any number of symbols with any number of graphical designs are considered within the scope of the invention. The nine symbols described hereinabove are illustrative of the inventive system and are not intended to limit the invention.

Upon moving a display pointer with the use of a mouse, not shown, to a white space on a display screen (an area in which no executable actions appear), the cluster of symbols 10 appears at the location where the display pointer is pointing, as the user “clicks” the left mouse button. The symbol(s) “pin” themselves to the “white space” area (remain fixed in that location regardless of pointer movement) and await the movement of the pointer to the appropriate, nearby symbol. Once hovered over the appropriate symbol, the left mouse button is released and the action is undertaken.

Where there is no mouse attached and the computer is a portable computing device and has a display pointer panel used for finger manipulation of the display pointer and upon movement to a “white space” area, the symbols will either automatically appear or be summoned by a “tap” in the display pointer panel area. This will be set as an option to the user in a menu above. Either way, the symbol(s) appear, “pin” themselves to the “white space” area (remain fixed in that location regardless of pointer movement) and await the movement of the pointer to the appropriate, nearby symbol. Once hovered over the appropriate symbol, the left mouse button is clicked or the navigation panel (touchpad) is “tapped” and the action is undertaken.

Invoking or launching a function from that pointer-centric location is preferable to moving the display pointer/mouse pointer to the extreme border of the display screen.

Referring now to FIG. 2, there is show the same cluster of symbols, this time arranged so as to fit as close to a right-click-invoked drop-down menu. When the menu is invoked in the upper half of the screen, the upper cluster 30 will appear. When invoked in the lower half of the screen, the lower cluster 32 will appear. This is so the mouse pointer or display pointer can be as close to the cluster as is possible for subsequent clicking on a graphic symbol within the cluster. To execute, the user depresses and releases the right mouse button or the notebook/laptop touchpad-equivalent of the right mouse button at which time the drop down menu appears. The user then selects the appropriate action by moving to the appropriate element 12-28 and pressing the left mouse button, the notebook/laptop touchpad-equivalent of the left mouse button or by “tapping” the notebook/laptop touchpad.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

All programming art necessary to make these various embodiments of the POSITIONAL NAVIGATION GRAPHIC LINK SYSTEM behave as described, are currently in use by those skilled in the art. Bringing graphic symbols to the mouse pointer, pinning a graphic symbol, permitting the selection of and invocation of the desired action and making a graphic appear automatically in a white space are all simple functions exemplary of current art. The difference is that the novelty and lack of obviousness of this invention have yet to be claimed by others.

Having thus described the invention, what is desired to be protected by Letters Patent is presented in the subsequently appended claims.

What is claimed is:

1. A positional navigation link system for displaying an active graphic symbol at a user-selected location on a display screen, comprising:
a) means for storing an active graphic symbol;
b) means for displaying said active graphic symbol at a location on a display screen selected by a user; and
c) means for activating a function represented by said active graphic symbol by said user;
whereby said active graphic symbol and the function represented thereby are conveniently accessible by said user at said location on a display screen.

2. The positional navigation link system in accordance with claim 1, wherein said active graphic symbol comprises a plurality of active graphic symbols arranged in a cluster.

3. The positional navigation link system in accordance with claim 1, wherein said location on a display screen comprises a location thereon on which no executable actions appear, when the left click is used to invoke the positional navigational link.

4. The positional navigation link system in accordance with claim 1, wherein said location on a display screen comprises a location thereon on which no executable actions appear, when the option to use only display pointer or mouse pointer movement to invoke the positional navigational link.

5. The positional navigation link system in accordance with claim 1, wherein said location on a display screen comprises a location thereon on which has no constraints for display pointer or mouse pointer placement meaning the display pointer or mouse pointer can be placed anywhere, when the right click is used to invoke the positional navigational link.

6. The positional navigation link system in accordance with claim 1, wherein said function is at least one of the group: close the window, minimize the window, go to previous window, go to next window, go to top of window, go to bottom of window, refresh, print and save.

7. The positional navigation link system in accordance with claim 1, wherein said means for displaying said active graphic symbol is launched by left clicking on a mouse or pointer device.

8. The positional navigation link system in accordance with claim 1, wherein said means for displaying said active graphic symbol is launched by simple movement of the display pointer or mouse pointer in a white space display area.

9. The positional navigation link system in accordance with claim 1, wherein said means for displaying said active graphic symbol is launched by right clicking on a mouse or pointer device.

10. The positional navigation link system in accordance with claim 2, wherein said cluster of symbols appears at said location on a display screen comprises a location thereon on which no executable actions appear, when the left click is used to invoke the positional navigational link.

11. The positional navigation link system in accordance with claim 2, wherein said cluster of symbols appears at said location on a display screen comprises a location thereon on which no executable actions appear, when only display pointer or mouse pointer movement is used to invoke the positional navigational link.

12. The positional navigation link system in accordance with claim 2, wherein said cluster of symbols appears at said location on a display screen comprises a location thereon on which has no constraints for display pointer or mouse pointer placement meaning the display pointer or mouse pointer can be placed anywhere, when the right click is used to invoke the positional navigational link.
